(19) United States
(12) Patent Application Publication
(10) Pub. No.: US 2026/0012110 A1
(43) Pub. Date: Jan. 8, 2026

(54) METHOD AND SYSTEM FOR SINKING ELECTRICAL ENERGY FROM A MOTOR

(71) Applicant: Ocado Innovation Limited, Hatfield (GB)

(72) Inventor: Joel GREBERG, Sundbyberg (SE)

(21) Appl. No.: 19/323,999

(22) Filed: Sep. 9, 2025

Related U.S. Application Data
(63) Continuation of application No. PCT/EP2024/055909, filed on Mar. 6, 2024.

(30) Foreign Application Priority Data
Mar. 10, 2023 (GB) 2303565.2

(51) Int. Cl. H02P 5/00; H02P 21/00

(52) U.S. Cl. CPC H02P 5/00; H02P 21/0003

(57) ABSTRACT

A method and system for sinking electrical energy from a motor is disclosed. The method and system diverts generated electrical energy from a motor to a sink.

### CROSS-REFERENCE TO RELATED APPLICATIONS

This application is a continuation of PCT International Patent Application No. PCT/EP2024/055909, filed on Mar. 6, 2024, which claims priority to UK Patent Application No. GB2303565.2, filed on Mar. 10, 2023, the entire contents of each of which are hereby incorporated by reference.

### TECHNICAL FIELD

The present invention relates to a method and system for sinking energy from a motor, such as those used in a load-handling device.

### BACKGROUND

Some commercial and industrial activities require systems that enable the storage and retrieval of a large number of different products. WO2015/185628A describes a storage and fulfilment system in which stacks of storage containers are arranged within a grid storage structure. The containers are accessed from above by load-handling devices operative on rails or tracks located on the top of the grid storage structure. The load-handling devices are further described in WO2015/019055A1.

Within the storage and fulfilment system, it is important that the load-handling devices divert energy generated by motors to avoid components operating above their ratings. It is against this background that the present invention has been devised.

### SUMMARY

In a first aspect, there is a system for dissipating energy generated by a motor, the system comprising: a first motor; a second motor; and a controller configured to: drive the first motor; detect electrical energy generated by the first motor; and divert the generated electrical energy to the second motor. This means the second motor can sink the electrical energy generated by the first motor and prevent damage to the system. The second motor can also act as a heat sink.

The controller may be configured to use field oriented control or vector control to control the second motor to sink the generated electrical energy. This means the sinking of the generated electrical energy can be accurately controlled.

The controller may configured to use field orientated control or vector control to sink all of the generated electrical energy in a direct axis of the second motor. This means the second motor does not produce torque when sinking the electrical energy generated by the first motor.

The system may comprise a bus bar configured to deliver power to the first and/or second motors, wherein the controller is configured to monitor a voltage on the bus bar to detect energy generated by the first motor. This means any potential damage to the system can be proactively identified.

The controller may be configured to divert the generated electrical energy to the second motor upon the voltage on the bus bar meeting a threshold. This means any damage to the system and its circuits can be avoided.

The controller may be configured to divert the generated electrical energy until the voltage on the bus bar is lower than the threshold, or a current limit of the second motor is reached, or a temperature limit of the second motor is reached. This means the system operates within safe limits.

A set point of a current in the direct axis may be increased until the voltage on the bus bar is lower than the threshold, or the current limit of the second motor is reached, or the temperature limit of the second motor is reached. This means the electrical energy that is generated by the first motor is always diverted to the second motor, and the system otherwise can function normally.

The system may further comprise a third motor, wherein the controller is configured to divert a portion of the generated electrical energy to the third motor. This means additional sinking capacity can be used by the system if necessary.

The system may comprise a power supply, such as a battery, wherein the controller is configured to divert a portion of the generated electrical energy to the power supply. This means the battery can be recharged.

The second motor or the third motor may comprise a multi phase motor such as a permanent magnet synchronous motor, PMSM. The low phase resistance of the PMSM aids the sinking of the electrical energy generated by the first motor.

A load-handling device may comprise the system wherein the load-handling device may be configured to lift and move storage containers stacked in a grid framework structure comprising: a first set of parallel rails or tracks and a second set of parallel rails or tracks extending substantially perpendicularly to the first set of rails or tracks in a substantially horizontal plane to form a grid pattern comprising a plurality of grid spaces, wherein the grid is supported by a set of uprights to form a plurality of vertical storage locations beneath the grid for containers to be stacked between and be guided by the uprights in a vertical direction through the plurality of grid spaces, the load-handling device may comprise: a body or skeleton mounted on a first set of wheels being configured to engage with the first set of parallel tracks and a second set of wheels being configured to engage with the second set of parallel tracks; and a drive assembly comprising either the first motor or the second motor, wherein either the first motor or the second motor is configured to drive the first or second sets of wheels to move the load-handling device along the first or second set of parallel rails respectively; and a container-lifting assembly comprising the other of either the first motor or the second motor, wherein either the other of the first motor or the second motor is configured to raise or lower a gripping device in the vertical direction. This means each of first and second functionalities of the load-handling device can provide a sink when the second and first functionalities respectively, are performed.

A load-handling device may comprise the system wherein the load-handling device may be configured to lift and move storage containers stacked in a grid framework structure comprising: a first set of parallel rails or tracks and a second set of parallel rails or tracks extending substantially perpendicularly to the first set of rails or tracks in a substantially horizontal plane to form a grid pattern comprising a plurality of grid spaces, wherein the grid is supported by a set of uprights to form a plurality of vertical storage locations beneath the grid for containers to be stacked between and be guided by the uprights in a vertical direction through the plurality of grid spaces, the load-handling device may comprise: a body or skeleton mounted on a first set of wheels being configured to engage with the first set of parallel tracks and a second set of wheels being configured to engage with the second set of parallel tracks; and a drive assembly comprising either the first motor or the second motor, wherein either the first motor or the second motor is configured to drive the first or second sets of wheels to move the load-handling device along the first or second set of parallel rails respectively; and a direction-change assembly comprising the other of either the first motor or the second motor, wherein either the other of the first motor or the second motor is configured to raise or lower the first set of wheels, and or lower or raise the second set of wheels with respect to the body or skeleton to engage and disengage the wheels with the parallel tracks. This means each of first and second functionalities of the load-handling device can provide a sink when the second and first functionalities respectively, are performed.

A load-handling device may comprise the system wherein the load-handling device may be configured to lift and move storage containers stacked in a grid framework structure comprising: a first set of parallel rails or tracks and a second set of parallel rails or tracks extending substantially perpendicularly to the first set of rails or tracks in a substantially horizontal plane to form a grid pattern comprising a plurality of grid spaces, wherein the grid is supported by a set of uprights to form a plurality of vertical storage locations beneath the grid for containers to be stacked between and be guided by the uprights in a vertical direction through the plurality of grid spaces, the load-handling device may comprise: a body or skeleton mounted on a first set of wheels being configured to engage with the first set of parallel tracks and a second set of wheels being configured to engage with the second set of parallel tracks; and a container-lifting assembly comprising either the first motor or the second motor, wherein either the first motor or the second motor is configured to raise or lower a gripping device in the vertical direction; and a direction-change assembly comprising the other of either the first motor or the second motor, wherein either the other of the first motor or the second motor is configured to raise or lower the first set of wheels, and or lower or raise the second set of wheels with respect to the body or skeleton to engage and disengage the wheels with the parallel tracks. This means each of first and second functionalities of the load-handling device can provide a sink when the second and first functionalities respectively, are performed.

A load-handling device may comprise the system wherein the load-handling device may be configured to lift and move storage containers stacked in a grid framework structure comprising: a first set of parallel rails or tracks and a second set of parallel rails or tracks extending substantially perpendicularly to the first set of rails or tracks in a substantially horizontal plane to form a grid pattern comprising a plurality of grid spaces, wherein the grid is supported by a set of uprights to form a plurality of vertical storage locations beneath the grid for containers to be stacked between and be guided by the uprights in a vertical direction through the plurality of grid spaces, the load-handling device may comprise: a body or skeleton mounted on a first set of wheels being configured to engage with the first set of parallel tracks and a second set of wheels being configured to engage with the second set of parallel tracks; and a drive assembly comprising the first motor and the second motor, wherein the first motor is configured to drive the first set of wheels to move the load-handling device along the first set of parallel rails, and wherein the second motor is configured to drive the second set of wheels to move the load-handling device along the second set of parallel rails; and optionally a direction-change assembly configured to raise or lower the first set of wheels, and or lower or raise the second set of wheels with respect to the body or skeleton to engage and disengage the wheels with the parallel tracks. This means each of first and second functionalities (the X- and Y-direction travel in this case) of the load-handling device can provide a sink when the second and first functionalities respectively, are performed.

In a second aspect, there is a method for diverting electrical energy using the system of any preceding aspect, wherein the method comprises: using the controller to: drive the first motor; detect electrical energy generated by the first motor; and divert the generated electrical energy to the second motor.

In a third aspect, there is a computer program comprising instructions which, when the program is executed by a computer, cause the computer to carry out the method of the second aspect.

### DESCRIPTION OF THE DRAWINGS

The present invention is described with reference to one or more exemplary embodiments as depicted in the accompanying drawings, wherein:

FIG. 1 shows a storage structure and containers;

FIG. 2 shows track on top of the storage structure illustrated in FIG. 1;

FIG. 3 shows load-handling devices on top of the storage structure illustrated in FIG. 1;

FIG. 4 shows a single load-handling device with container-lifting means in a lowered configuration;

FIG. 5A shows a cutaway view of a single load-handling device with container-lifting means in a raised configuration, and FIG. 5B shows a cutaway view of a single load-handling device with container-lifting means in a lowered configuration;

FIG. 6 is a schematic illustration of a load-handling device with a direction-change assembly;

FIG. 7 shows an example container-lifting assembly;

FIG. 8 is a schematic illustration of a load-handling device according to the invention;

FIG. 9 shows a method according to the invention; and

FIG. 10 shows a system according to the invention.

### DETAILED DESCRIPTION

Online retail businesses selling multiple product lines, such as online grocers and supermarkets, require systems that can store tens or hundreds of thousands of different product lines. The use of single-product stacks in such cases can be impractical since a vast floor area would be required to accommodate all of the stacks required. Furthermore, it can be desirable to store small quantities of some items, such as perishables or infrequently ordered goods, making single-product stacks an inefficient solution.

International patent application WO 98/049075A (Autostore), the contents of which are incorporated herein by reference, describes a system in which multi-product stacks of containers are arranged within a frame structure.

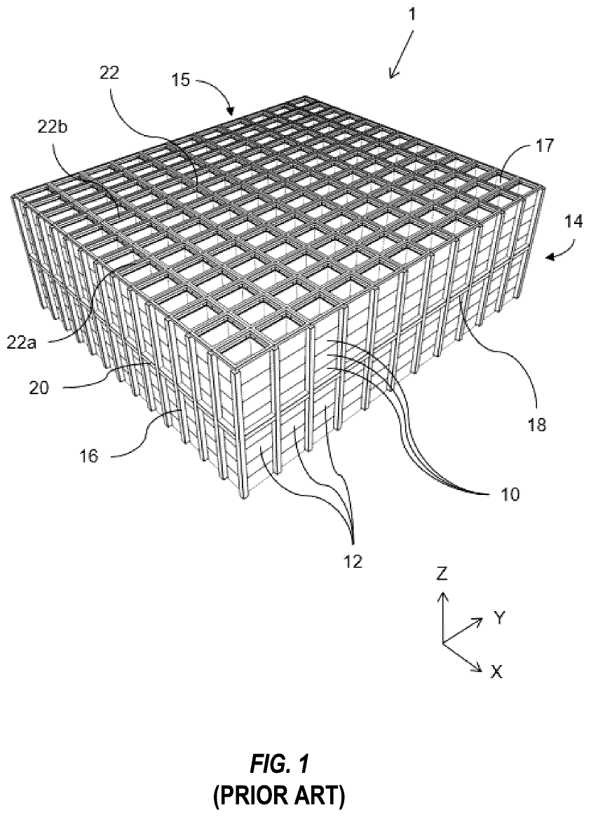

PCT Publication No. WO2015/185628A (Ocado) describes a further known storage and fulfilment system in which stacks of containers are arranged within a grid framework structure. The containers are accessed by one or more load-handling devices, otherwise known as “bots”, operative on tracks located on the top of the grid framework structure. A system of this type is illustrated schematically in FIGS. 1 to 3 of the accompanying drawings.

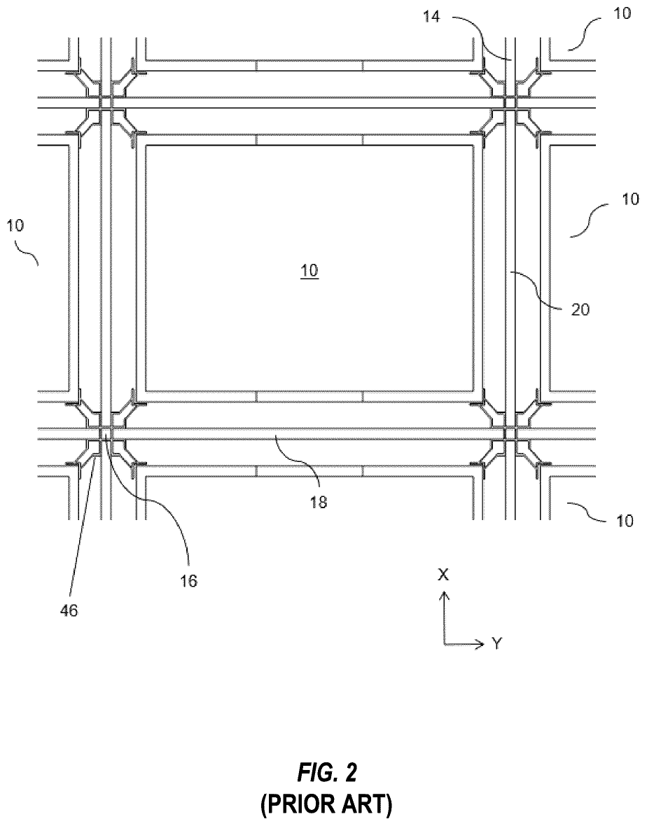

As shown in FIGS. 1 and 2, stackable containers 10, also known as “bins”, are stacked on top of one another to form stacks 12. The stacks 12 are arranged in a grid framework structure 14, e.g. in a warehousing or manufacturing environment. The grid framework structure 14 is made up of a plurality of storage columns or grid columns. Each grid in the grid framework structure has at least one grid column to store a stack of containers. FIG. 1 is a schematic perspective view of the grid framework structure 14, and FIG. 2 is a schematic top-down view showing a stack 12 of bins 10 arranged within the grid framework structure 14. Each bin 10 typically holds a plurality of product items (not shown). The product items within a bin 10 may be identical or different product types depending on the application.

The grid framework structure 14 comprises a plurality of upright members 16 that support horizontal members 18, 20. A first set of parallel horizontal members 18 is arranged perpendicularly to a second set of parallel horizontal members 20 in a grid pattern to form a horizontal grid structure 15 supported by the upright members 16. The members 16, 18, 20 are typically manufactured from metal. The bins 10 are stacked between the members 16, 18, 20 of the grid framework structure 14, so that the grid framework structure 14 guards against horizontal movement of the stacks 12 of bins 10 and guides the vertical movement of the bins 10.

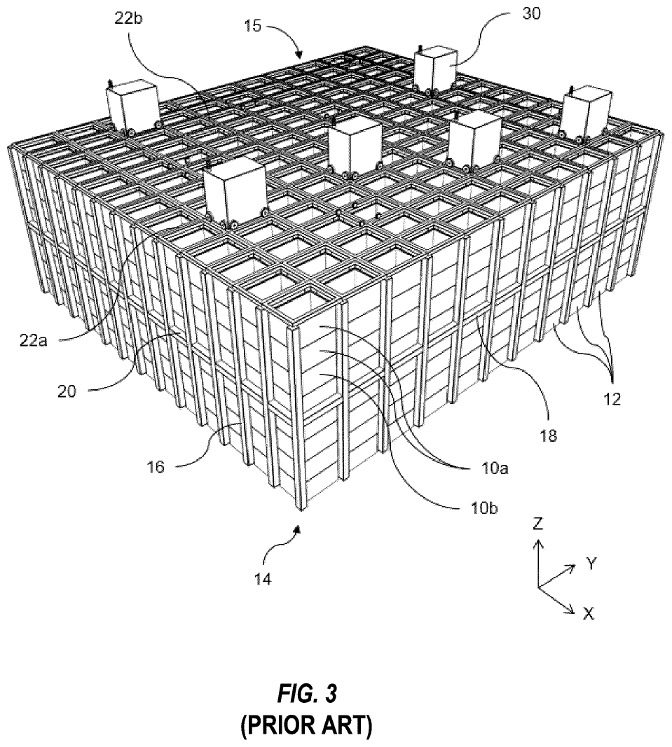

The top level of the grid framework structure 14 comprises a grid or grid structure 15, including rails or tracks 22 arranged in a grid pattern across the top of the stacks 12. Referring to FIG. 3, the rails or tracks 22 guide a plurality of load-handling devices 30. A first set of rails or tracks 22a of parallel rails or tracks 22 guide movement of the robotic load-handling devices 30 in a first direction (e.g. an X-direction) across the top of the grid framework structure 14. A second set of rails or tracks 22b of parallel rails or tracks 22, arranged perpendicular to the first set of rails or tracks 22a, guide movement of the load-handling devices 30 in a second direction (e.g. a Y-direction), perpendicular to the first direction. In this way, the rails or tracks 22 allow the robotic load-handling devices 30 to move laterally in two dimensions in the horizontal X-Y plane. A load-handling device 30 can be moved into position above any of the stacks 12.

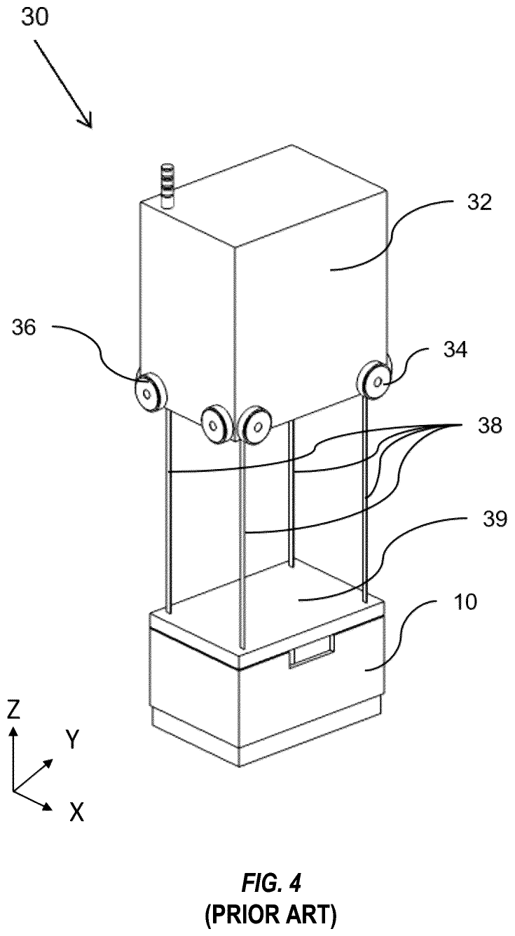

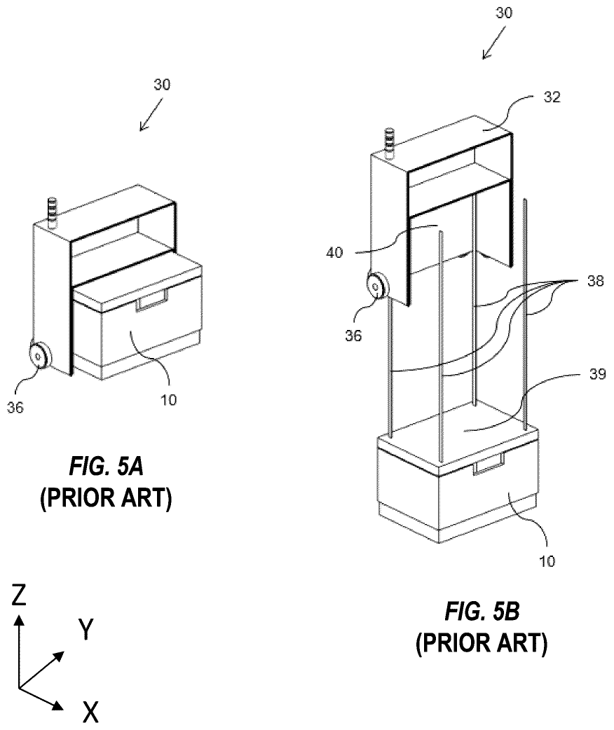

A known form of load-handling device 30—shown in FIGS. 4, 5A and 5B—is described in PCT Patent Publication No. WO2015/019055 (Ocado), hereby incorporated by reference, where each load-handling device 30 covers a single grid cell 17 of the grid framework structure 14. This arrangement allows a higher density of load handlers and thus a higher throughput for a given sized system.

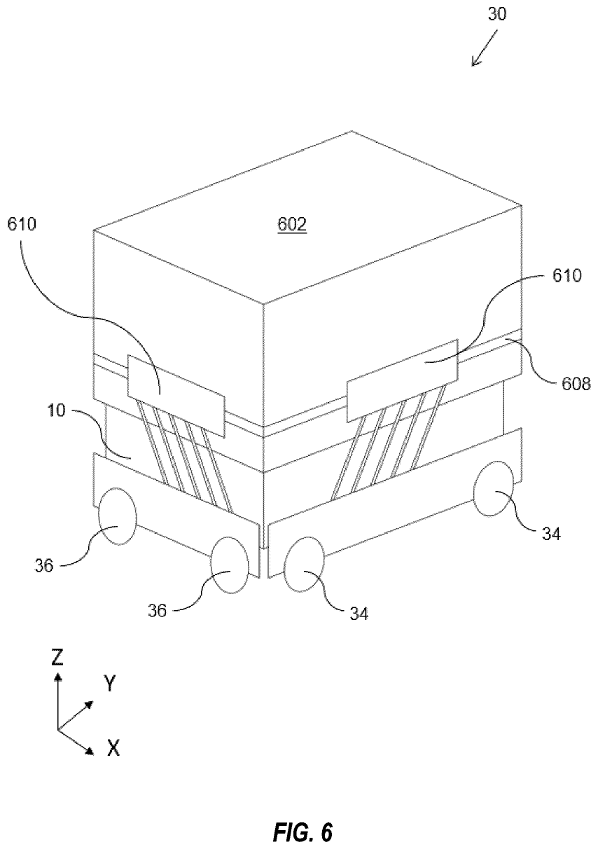

The load-handling device 30 comprises a vehicle 32, which is arranged to travel on the rails or tracks 22 of the grid framework structure 14. A first set of wheels 34, consisting of a pair of wheels 34 on the front of the vehicle 32 and a pair of wheels 34 on the back of the vehicle 32, is arranged to engage with two adjacent rails of the first set 22a of rails or tracks 22. Similarly, a second set of wheels 36, consisting of a pair of wheels 36 on each side of the vehicle 32, is arranged to engage with two adjacent rails of the second set of rails or tracks 22b. Each set of wheels 34, 36 can be lifted and lowered, by way of a direction-change assembly (an example of which is shown in FIG. 6), so that either the first set of wheels 34 or the second set of wheels 36 is engaged with the respective set of rails or tracks 22a, 22b at any one time. For example, when the first set of wheels 34 is engaged with the first set of rails or tracks 22a and the second set of wheels 36 is lifted clear from the rails or tracks 22, the first set of wheels 34 can be driven, by way of a drive assembly, housed in the vehicle 32, to move the load-handling device 30 in the X-direction. To achieve movement in the Y-direction, the first set of wheels 34 is lifted clear of the rails or tracks 22, and the second set of wheels 36 is lowered into engagement with the second set of rails or tracks 22b. The drive assembly can then be used to drive the second set of wheels 36 to move the load-handling device 30 in the Y direction.

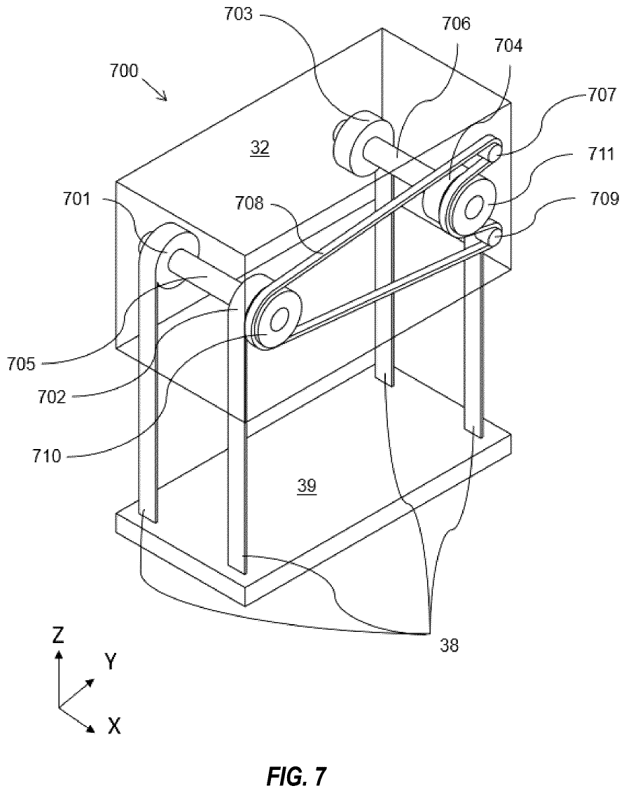

The load-handling device 30 is equipped with a container-lifting device or assembly (an example of which is shown in FIG. 7), e.g. a crane mechanism, to lift a storage container from above. The lifting device comprises a winch tether or cable 38 wound on a spool or reel and a gripper device 39. The lifting device shown in FIG. 4 comprises a set of four lifting cables 38 extending in a vertical direction. The cables 38 are connected at or near the respective four corners of the gripper device 39, e.g. a lifting frame, for releasable connection to a bin 10. For example, a respective cable 38 is arranged at or near each of the four corners of the gripper device. The gripper device 39 is configured to releasably grip the top of a bin 10 to lift it from a stack of containers in a storage system of the type shown in FIGS. 1 and 2. For example, the gripper device 39 may include pins (not shown) that mate with corresponding holes (not shown) in the rim that forms the top surface of bin 10, and sliding clips (not shown) that are engageable with the rim to grip the bin 10. The clips are driven to engage with the bin 10 by a suitable drive mechanism housed within the gripper device 39, powered and controlled by signals carried through the cables 38 themselves or a separate control cable (not shown).

To remove a bin 10 from the top of a stack 12, the load-handling device 30 is first moved in the X- and Y-directions to position the gripper device 39 above the stack 12. The gripper device 39 is then lowered vertically in the Z-direction to engage with the bin 10 on the top of the stack 12, as shown in FIGS. 4 and 5B. The gripper device 39 grips the bin 10, and is then pulled upwards by the cables 38, with the bin 10 attached. At the top of its vertical travel, the bin 10 is held above the rails or tracks 22 accommodated within the body of vehicle 32. In this way, the load-handling device 30 can be moved to a different position in the X-Y plane, carrying the bin 10 along with it, to transport the bin 10 to another location. On reaching the target location (e.g. another stack 12, an access point in the storage system, or a conveyor belt) the bin or container 10 can be lowered from the container receiving portion and released from the gripper device 39. The cables 38 are long enough to allow the load-handling device 30 to retrieve and place bins from any level of a stack 12, e.g. including the floor level.

As shown in FIG. 3, a plurality of identical load-handling devices 30 is provided so that each load-handling device 30 can operate simultaneously to increase the system's throughput. The system illustrated in FIG. 3 may include specific locations, known as ports, at which bins 10 can be transferred into or out of the system. An additional conveyor system (not shown) is associated with each port so that bins 10 transported to a port by a load-handling device 30 can be transferred to another location by the conveyor system, such as a picking station (not shown). Similarly, bins 10 can be moved by the conveyor system to a port from an external location, for example, to a bin-filling station (not shown), and transported to a stack 12 by the load-handling devices 30 to replenish the stock in the system.

Each load-handling device 30 can lift and move one bin 10 at a time. The load-handling device 30 has a container-receiving cavity or recess 40, in its lower part. The recess 40 is sized to accommodate the bin 10 when lifted by the lifting mechanism, as shown in FIGS. 5A and 5B. When in the recess, the bin 10 is lifted clear of the rails or tracks 22 beneath, so that the vehicle 32 can move laterally to a different grid location.

If it is necessary to retrieve a target bin 10b that is not located on the top of a stack 12, then the overlying non-target bins 10a must first be moved to allow access to the target bin 10b. This is achieved by an operation referred to hereafter as “digging”. Referring to FIG. 3, during a digging operation, one of the load-handling devices 30 lifts each non-target bin 10a sequentially from the stack 12 containing the target bin 10b and places it in a vacant position within another stack 12. The target bin 10b can then be accessed by the load-handling device 30 and moved to a port for further transportation.

Each of the provided load-handling devices 30 is remotely operable under the control of a central computer. Each individual bin 10 in the system is also tracked so that the appropriate bins 10 can be retrieved, transported and replaced as necessary. For example, during a digging operation, each non-target bin location is logged so that the non-target bin 10a can be tracked.

Wireless communications and networks may be used to provide the communication infrastructure from a master controller, e.g. via one or more base stations, to one or more load-handling devices operative on the grid structure. In response to receiving instructions from the central computer, a controller in the load-handling device is configured to control various driving mechanisms to control the movement of the load-handling device. For example, the load-handling device may be instructed to retrieve a container from a target storage column at a particular location on the grid structure. The instruction can include various movements in the X-Y plane of the grid structure 15. As previously described, once at the target storage column, the lifting mechanism can be operated to grip and lift the bin 10. Once the bin 10 is accommodated in the recess 40 of the load-handling device 30, it is subsequently transported to another location on the grid structure 15, e.g. a “drop-off port”. At the drop-off port, the container 10 is lowered to a suitable pick station to allow retrieval of any item in the storage container. Movement of the load-handling devices 30 on the grid structure 15 can also involve the load-handling devices 30 being instructed to move to a charging station, usually located at the periphery of the grid structure 15.

To maneuver the load-handling devices 30 on the grid structure 15, each of the load-handling devices 30 is equipped with motors for driving the wheels 34, 36. The wheels 34, 36 may be driven via one or more belts connected to the wheels or driven individually by a motor integrated into the wheels. For a single-cell load-handling device (where the footprint of the load-handling device 30 occupies a single grid cell 17), and the motors for driving the wheels can be integrated into the wheels due to the limited availability of space within the vehicle body. For example, the wheels of a single-cell load-handling device are driven by respective hub motors. Each hub motor comprises an outer rotor with a plurality of permanent magnets arranged to rotate about a wheel hub comprising coils forming an inner stator.

The system described with reference to FIGS. 1 to 5 has many advantages and is suitable for a wide range of storage and retrieval operations. In particular, it allows very dense storage of products and provides a very economical way of storing a wide range of different items in the bins 10 while also allowing reasonably economical access to all of the bins 10 when required for picking.

An example direction-change assembly (further described in PCT Publication No. WO2021175922A1 (Ocado) and PCT application no. PCT/EP2022/073670 (Ocado)) is shown in FIG. 6. As can be seen in FIG. 6, a first pair of direction-change mechanisms 610 are positioned on opposed faces within the body or skeleton 602 of the load-handling device for controlling the position of the first set of wheels 36, and a second pair of direction-change mechanisms 610 are positioned on orthogonal opposed faces within the body or skeleton of the load-handling device for controlling the position of the second set of wheels 36. Thus, each face of the load-handling device comprises a direction-change mechanism 610. The pairs of direction-change mechanisms 610 are coupled via a transfer or drive belt 608 that substantially circumnavigates the load-handling device body or skeleton 602, and is mechanically coupled to the direction-change mechanisms.

The output of the direction-change mechanisms is transferred to the wheels 34, 36 via a chassis which translates the horizontal movement of the direction-change mechanisms to a vertical movement of the wheels. In some arrangements, the direction-change mechanism may be attached to a rod arrangement extending along a face of the load-handling device 30 between each of the horizontal edges of the load-handling device 30 via a glide bearing. In turn the rod arrangement may be attached to corner pieces at first and second ends.

The wheels 34, 36 can be moved in unison, for example via a motor (not shown) and the drive belt 608 to engage X- and or Y-direction wheel sets with the rails of a storage system grid. Activating the motor in a clockwise direction may move a wheel mount on the face upwards to raise the wheels on the face, and lower the wheels on the face, perpendicular to the first face—or vice versa.

An example container-lifting assembly (further described in PCT application no. PCT/EP2022/081364 (Ocado)) is shown in FIG. 7. In FIG. 7, a lifting assembly 700 has four spools 701, 702, 703, and 704 to wind and unwind respective cables 38. Spools 701 and 702 are on drive shaft 705, whereas spools 703 and 704 are on drive shaft 706. Drive shafts 705 and 706, when driven by a motor, are configured to rotate in opposite directions. By rotating drive shafts 705 and 706 in opposite directions, respective cables 38 can be located at or near the corners of the lifting assembly. In particular, as shown in FIG. 7, the point at which each tether winds or unwinds to or from a spool is at or near a respective corner of the lifting assembly. This allows the tethers to connect to the container gripper device 39 at a respective corner of the gripping assembly, which increases stability when raising and lowering the container gripper device 39. FIG. 7 shows one example of how drive shafts 705, 706 can be rotated in opposite directions. Drive shafts 705 and 706 are connected to pulleys 710 and 711 respectively. Pulley 707 (or 709) is linked to the axle/shaft/rotor of a motor (not shown in FIG. 7). Drive belt 708 transmits the torque to pulleys 709, 710, and 711 in a way that ensures spools 701 and 702, and spools 703 and 704 rotate in opposite directions. In particular, pulleys 707 and 709 are arranged about pulley 711 to affect its opposite rotation to pulley 710.

It will now be appreciated that load-handling device 30 has three systems, each of which can use at least one motor: the direction-change assembly; the drive assembly; and the container-lifting assembly. Each of the motors, when undergoing rapid deceleration, tend to become generative. That is, the motors are generating more electrical power than they are consuming. Rapid deceleration of a motor may occur when the container-gripping assembly is approaching a container in the grid assembly, or the load-handling device is arriving at a desired position on the grid framework structure 14, or the direction-change assembly is completing a direction change. This generated electrical energy can potentially result in a power supply operating beyond its rating or capacity, which can then damage the power supply (i.e. a battery) and any connected circuitry. Although it is possible to feed the generated electrical energy back into the power supply, this is limited by the extent to which the power supply is charged. If the power supply (battery) is at or near full capacity, the power supply is unable to sink the generated electrical energy, and attempting to do so could damage the power supply.

It is known to use a brake resistor to sink the generated electrical energy and dissipate heat. Upon detection of the generated electrical energy, the brake resistor is connected (for example by using a MOSFET switch) to a power supply circuit to absorb the generated electrical energy and dissipate heat. However, in certain contexts, such as a load-handling device, the use of a brake resistor presents a problem in that significant space is required to effectively sink the generated electrical energy and dissipate the heat. Given the generated electrical energy can be significant in a load-handling device, brake resistors will scale in size accordingly. Circuitry to control the operation of the brake resistor also has to be accommodated. Therefore, it is desirable to sink the generated electrical energy without using a brake resistor. It should be appreciated that this problem is common to all systems in which electrical energy generated by motors has to be sunk. The above is merely illustrative of a motor used within a load-handling device. The ability to sink motor generated electrical energy in any system whilst avoiding the above problem is desirable.

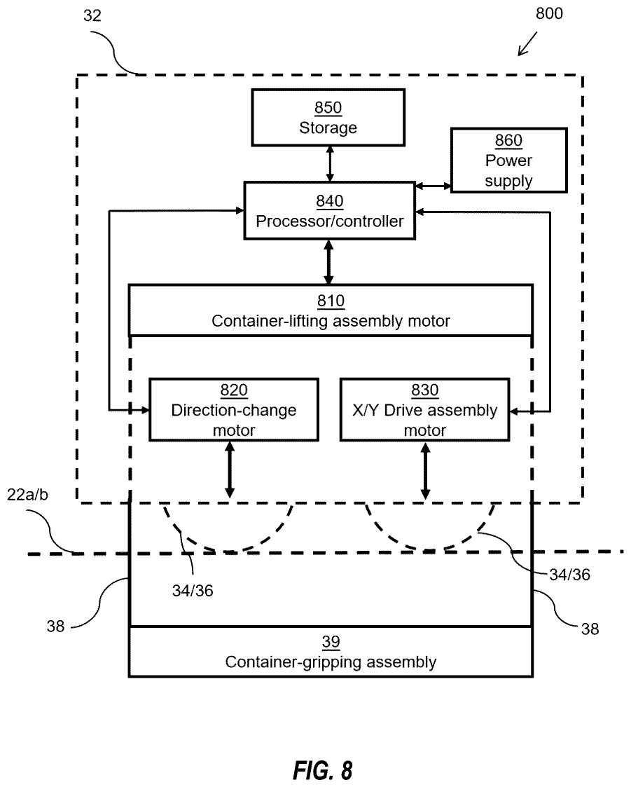

FIG. 8 shows a schematic 800 of load-handling device 30 in accordance with the invention. The dashed lines show the body of vehicle 32 of a load-handling device that travels on grid 22a/b via wheels 34/36. A container-lifting assembly (such as that shown in FIGS. 4, 5A, 5B, and 7) has a container-lifting assembly motor 810 that can be driven to raise and/or lower container gripper device 39. A direction-change assembly has a direction-change motor 820 that can be driven so that either the first set of wheels 34 or the second set of wheels 36 is engaged with the respective set of rails or tracks 22a, 22b at any one time. An X/Y drive assembly has an X and/or Y drive assembly motor 830 that can be driven to move the load-handling device 30 in the X- and/or Y-directions. A processor/controller 840 can receive and transmit data from and to each of the container-lifting assembly motor 810, direction-change motor 820, and the X and/or Y drive assembly motor(s) 830. The processor/controller 840 can also communicate with power supply 860 that is used to power each of the container-lifting assembly motor 810, direction-change motor 820, and the X and/or Y drive assembly motor(s) 830. Any data used by processor/controller 840 can be stored in storage 850. The data in storage 850 can be periodically transmitted for further processing via one or more networks, such as base stations.

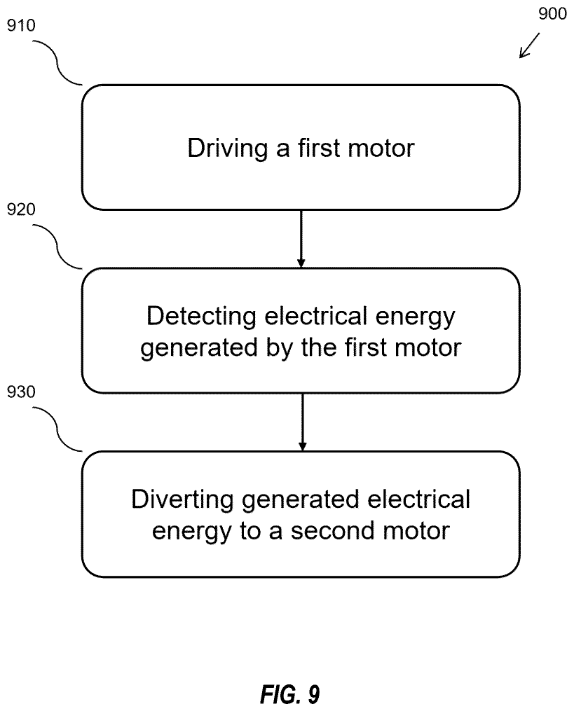

FIG. 9 shows the steps of a method 900 for use in a system that comprises two motors, such as those used in a load-handling device. It would be appreciated that the method of FIG. 9 could be carried out using a processor/controller (such as processor/controller 840 of a load-handling device of FIG. 8 for example). In step 910, a first motor (which could be one of: the container-lifting assembly motor 810, direction-change motor 820, or the X and/or Y drive assembly motor 830) is driven. The processor/controller (such as processor/controller 840) controls the speed, and thus the acceleration and deceleration of the first motor. When the first motor undergoes rapid deceleration, the first motor generates more electrical energy than it consumes.

In step 920, the electrical energy generated by the first motor is detected. This may be implemented by monitoring a voltage on a bus bar that connects a power supply to the first motor. Energy generated by the first motor will result in an increased voltage on the bus bar that can be detected using appropriate circuitry. The bus bar may be monitored to detect a threshold voltage that is indicative of generated electrical energy. For example, the threshold may be set to a rating of a power supply that powers the first motor. A voltage on the bus bar exceeding the threshold is indicative of generated electrical energy. It would be appreciated that the threshold can be set depending on the system in which the power supply, first motor, and second motor, are used.

In step 930, upon the threshold voltage being detected, the generated electrical energy is diverted to a second motor (which could be the one of: the container-lifting assembly motor 810, direction-change motor 820, or the X and/or Y drive assembly motor 830 that is not driven as the first motor). This means that generated electrical energy that could otherwise damage the power supply is diverted to the second motor. In this step, the second motor is not being driven. Armature windings of the second motor are found to act as an effective current and heat sink for the electrical energy generated by the first motor. In particular, a motor tends to have low resistance (or low phase resistance) and a relatively high thermal mass. Any damage to the power supply and/or the system can be avoided. Additionally, some of the electrical energy generated by the first motor may be directed to recharge the power supply.

The generated electrical energy may be diverted until one of the following conditions is met—1: the voltage on the bus bar decreases below the threshold voltage; 2: a current limit of the second motor is reached; and 3: a temperature limit of the second motor is reached. For condition 1, a proportional integral, PI, controller may be used to maintain the bus voltage at its threshold voltage. An input to the PI controller could be a difference between a measured voltage on the bus bar and the threshold voltage, where an output of the PI controller would be the current delivered to the second motor. Any appropriate sensor may be used to determine whether conditions 2 or 3 have been met. When either of conditions 2 or 3 are met, the generated electrical energy may be directed to recharge the power supply, or another motor of the system. If, however, direction to the power supply or another motor is not possible due to saturation of the power supply or unavailability of another motor, the braking performance of the first motor can be altered. That is, the deceleration (that resulted in the generated electrical energy) of the first motor is lowered.

In one implementation, the controller uses Field Oriented Control, FOC, or vector control with the second motor, which may be multi-phase motor such as a permanent magnet synchronous motor, PMSM. FOC or vector control controls the motor using two currents to define respective orthogonal d-axis (direct axis) and q-axis (quadrature axis) components. The d-axis produces magnetic flux, and the q-axis produces torque. It has been found that the current that defines the d-axis is generally lost compared to the torque producing current that defines the q-axis. Therefore, if the processor uses FOC or vector control to configure the motor to divert all of the generated electrical energy along the d-axis, there is no risk of the generated electrical energy producing torque in the second motor.

This can be useful in certain contexts such as when a load-handling device is stationary on the rails or tracks 22a, 22b, and the container lifting assembly is raising or lowering a container. In this scenario, the container-lifting assembly motor 810 would act as the first motor and one of the X/Y drive assembly motors 830 would act as the second motor. When the X and/or Y drive assembly motor 830 sinks the electrical energy generated by the container-lifting assembly motor 810, the sunk energy will not be diverted to the q-axis and the load-handling device will not move in the X/Y-directions. Considering the reverse scenario, where the one of the X/Y drive assembly motors 830 acts as the first motor, and the container-lifting assembly motor 810 acts as the second motor, there is no risk of the container-gripping assembly lowering when the load-handling device is moving along the rails or tracks 22a, 22b.

As mentioned above, depending on which direction the load-handling device is moving along the tracks, different motors can be used for travel in the X- and Y-directions. Therefore, if the first motor is the motor responsible for travel in the X-direction (or the X-direction), the second motor can be that responsible for travel in the Y-direction (or the X-direction). In this scenario, the set of wheels for travel in the Y-direction (or the X-direction) will not be engaged with the tracks, so even if the electrical energy is diverted to the q-axis (and thus introduces torque), there is no risk of the load-handling device moving in the Y-direction (or the X-direction). This means the use of field oriented control or vector control is not required thus simplifying the diversion of the generated electrical energy.

Similarly, the direction-change assembly motor can be configured not to generate torque when acting as the second motor. In general, the second motor of the load-handling device is prevented from performing its primary function (such as moving the load-handling device, or changing the direction of the load-handling device, or hoisting the container-gripping assembly) when acting as a sink for the electrical energy generated by a first motor of the load-handling device in the process of performing its primary function (such as moving the load-handling device, or changing the direction of the load-handling device, or hoisting the container-gripping assembly). More generally, the second motor is configured to sink the electrical energy generated by the first motor in a way that prevents the second motor generating torque.

To ensure that generated electrical energy is diverted along the d-axis, the d-axis of the second motor may be tracked, and the generated electrical energy can be directed along the last tracked orientation of the d-axis before the second motor acts as a sink for the electrical energy generated by the first motor. Alternatively, the q-axis may be tracked and the d-axis can be applied in an orthogonal direction to the last tracked orientation of the q-axis before it acts as a sink for the electrical energy generated by the first motor. Given the d-axis and the q-axis are orthogonal and relative to the rotor, tracking the position of the rotor can be used to determine the actual position of the d-axis and the q-axis. As opposed to using the last-known position of the d-axis before the second motor acts as a sink for the electrical energy generated by the first motor, the d-axis can be tracked in real-time. This ensures that the d-axis is used to sink the current regardless of the d-axis and q-axis moving.

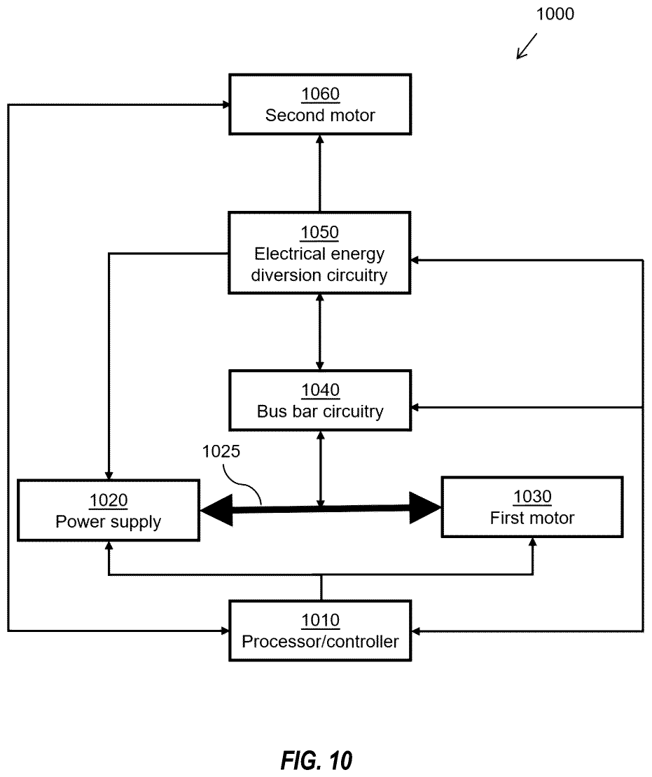

FIG. 10 shows a schematic of circuit blocks that can be used to implement the method of FIG. 9. As shown by FIG. 10, a processor/controller 1010 interfaces with a power supply 1020 such as a battery, first motor 1030, bus bar circuitry 1040, electrical energy diversion circuitry 1050, and second motor 1060. The processor/controller 1010 communicates with the power supply 1020 and the first motor 1030 to drive the motor in accordance with step 910. Bus bar circuitry 1040 interfaces with bus bar 1025 to monitor a voltage on the bus bar 1025. Bus bar circuitry 1040 interfaces with processor/controller 1010 and electrical energy diversion circuitry 1050 to control the electrical energy diversion upon a threshold voltage being detected on the bus bar. The bus bar circuitry 1040 and the electrical energy diversion circuitry 1050 can then divert excess voltage on the bus bar to the second motor 1060. The bus bar circuitry 1040 and electrical energy diversion circuitry 1050 can be implemented using the PI controller described above. The processor/controller 1010 interfaces with the second motor 1060, which can be used to control the second motor to divert the energy generated by the first motor along the d-axis of the second motor.

In this document, the language “movement in the n-direction” (and related wording), where n is one of x, y and z, is intended to mean movement substantially along or parallel to the n-axis, in either direction (i.e. towards the positive end of the n-axis or towards the negative end of the n-axis).

In this document, the word “connect” and its derivatives are intended to include the possibilities of direct and indirection connection. For example, “x is connected to y” is intended to include the possibility that x is directly connected to y, with no intervening components, and the possibility that x is indirectly connected to y, with one or more intervening components. Where a direct connection is intended, the words “directly connected”, “direct connection” or similar will be used. Similarly, the word “support” and its derivatives are intended to include the possibilities of direct and indirect contact. For example, “x supports y” is intended to include the possibility that x directly supports and directly contacts y, with no intervening components, and the possibility that x indirectly supports y, with one or more intervening components contacting x and/or y. The word “mount” and its derivatives are intended to include the possibility of direct and indirect mounting. For example, “x is mounted on y” is intended to include the possibility that x is directly mounted on y, with no intervening components, and the possibility that x is indirectly mounted on y, with one or more intervening components.

In this document, the word “comprise” and its derivatives are intended to have an inclusive rather than an exclusive meaning. For example, “x comprises y” is intended to include the possibilities that x includes one and only one y, multiple y's, or one or more y's and one or more other elements. Where an exclusive meaning is intended, the language “x is composed of y” will be used, meaning that x includes only y and nothing else.

In this document, “controller” is intended to include any hardware which is suitable for controlling (e.g. providing instructions to) one or more other components. For example, a processor equipped with one or more memories and appropriate software to process data relating to a component or components and send appropriate instructions to the component(s) to enable the component(s) to perform its/their intended function(s).

As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The invention can take the form of an entirely hardware embodiment, an entirely software embodiment or an embodiment containing both hardware and software elements. In a preferred embodiment, the invention is implemented in software.

Furthermore, the invention can take the form of a computer program embodied as a computer-readable medium having computer executable code for use by or in connection with a computer. For the purposes of this description, a computer readable medium can be any tangible apparatus that can contain, store, communicate, propagate, or transport the program for use by or in connection with the computer. Moreover, a computer-readable medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

The flow diagrams in the figures illustrate the architecture, functionality, and operation of possible implementations of methods according to various embodiments of the present invention. In this regard, each block in the flow diagram may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be performed substantially concurrently, or the blocks may sometimes be performed in the reverse order, depending upon the functionality involved. It will also be noted that each block of the flow diagrams, and combinations of blocks in the flow diagrams, can be implemented by special purpose hardware-based systems that perform the specified functions or acts, or combinations of special purpose hardware and computer instructions.

It will be understood that the above description of is given by way of example only and that various modifications may be made by those skilled in the art. Although various embodiments have been described above with a certain degree of particularity, or with reference to one or more individual embodiments, those skilled in the art could make numerous alterations to the disclosed embodiments without departing from the scope of this invention.

What is claimed is:

1. A system for dissipating energy generated by a motor, the system comprising:
a first motor;
a second motor; and
a controller configured to:
drive the first motor;
detect electrical energy generated by the first motor;
divert at least a first portion of the electrical energy to the second motor; and
control, via field oriented control or vector control, the second motor to sink the at least the first portion of the electrical energy in a direct axis of the second motor.

2. The system of claim 1, wherein the system further comprises a bus bar configured to deliver power to at least one of the first motor or the second motor, wherein to detect the electrical energy generated by the first motor, the controller is configured to monitor a voltage on the bus bar to detect the electrical energy generated by the first motor.

3. The system of claim 2, wherein to divert the at least the first portion of the electrical energy generated by the first motor to the second motor, the controller is configured to, based on satisfaction of a threshold by the voltage on the bus bar, divert the at least the first portion of the electrical energy to the second motor.

4. The system of claim 3, wherein to divert the at least the first portion of the electrical energy generated by the first motor to the second motor, the controller is configured to divert the at least the first portion of the electrical energy generated by the first motor to the second motor until:
the voltage on the bus bar is lower than the threshold;
a current limit of the second motor is reached; or
a temperature limit of the second motor is reached.

5. The system of claim 4, wherein to control the second motor to sink the at least the first portion of the electrical energy, the controller is configured to increase a set point of a current in the direct axis of the second motor until:
the voltage on the bus bar is lower than the threshold;
the current limit of the second motor is reached; or
the temperature limit of the second motor is reached.

6. The system of claim 1, further comprising a third motor, wherein the controller is configured to divert at least a second portion of the electrical energy generated by the first motor to the third motor.

7. The system of claim 1, further comprising a power supply, wherein the controller is further configured to divert at least a second portion of the electrical energy generated by the first motor to the power supply.

8. The system of claim 1, wherein the second motor comprises a multi-phase motor.

9. The system of claim 1, further comprising a load-handling device comprising the first motor, the second motor, the controller.

10. The system of claim 9, wherein the load-handling device is configured to lift and move storage containers stacked in a grid framework structure, the grid framework structure comprising:
a first set of parallel rails or tracks and a second set of parallel rails or tracks, the second set of parallel rails or tracks extending substantially perpendicularly to the first set of parallel rails or tracks in a substantially horizontal plane to form a grid pattern, the grid pattern comprising a plurality of grid spaces, wherein the grid pattern is supported by a set of uprights to form a plurality of vertical storage locations beneath the grid pattern for storage containers to be stacked between and be guided by the set of uprights in a vertical direction through the plurality of grid spaces, the load-handling device comprising:
a body or skeleton mounted on:
a first set of wheels configured to engage with the first set of parallel rails or tracks; and
a second set of wheels configured to engage with the second set of parallel rails or tracks;
a drive assembly comprising one of the first motor or the second motor, wherein the one of the first motor or the second motor is configured to drive at least one of the first set of wheels or the second set of wheels to move the load-handling device along the first set of parallel rails or tracks or the second set of parallel rails or tracks respectively; and
a container-lifting assembly comprising another of the first motor or the second motor, wherein the other of the first motor or the second motor is configured to raise or lower a gripping device in the vertical direction.

11. The system of claim 9, wherein the load-handling device is configured to lift and move storage containers stacked in a grid framework structure, the grid framework structure comprising:
a first set of parallel rails or tracks and a second set of parallel rails or tracks, the second set of parallel rails or tracks extending substantially perpendicularly to the first set of parallel rails or tracks in a substantially horizontal plane to form a grid pattern, the grid pattern comprising a plurality of grid spaces, wherein the grid pattern is supported by a set of uprights to form a plurality of vertical storage locations beneath the grid pattern for storage containers to be stacked between and be guided by the set of uprights in a vertical direction through the plurality of grid spaces, the load-handling device comprising:
a body or skeleton mounted on:
a first set of wheels configured to engage with the first set of parallel rails or tracks; and
a second set of wheels configured to engage with the second set of parallel rails or tracks;
a drive assembly comprising one of the first motor or the second motor, wherein the one of the first motor or the second motor is configured to drive at least one of the first set of wheels or the second set of wheels to move the load-handling device along the first set of parallel rails or tracks or the second set of parallel rails or tracks respectively; and
a direction-change assembly comprising another of the first motor or the second motor, wherein the other of the first motor or the second motor is configured to at least one of:
raise or lower the first set of wheels with respect to the body or skeleton of the load-handling device to engage or disengage the first set of wheels with the first set of parallel rails or tracks, or
lower or raise the second set of wheels with respect to the body or skeleton of the load-handling device to engage or disengage the second set of wheels with the second set of parallel rails or tracks.

12. The system of claim 9, wherein the load-handling device is configured to lift and move storage containers stacked in a grid framework structure, the grid framework structure comprising:
a first set of parallel rails or tracks and a second set of parallel rails or tracks, the second set of parallel rails or tracks extending substantially perpendicularly to the first set of parallel rails or tracks in a substantially horizontal plane to form a grid pattern, the grid pattern comprising a plurality of grid spaces, wherein the grid pattern is supported by a set of uprights to form a plurality of vertical storage locations beneath the grid pattern for storage containers to be stacked between and be guided by the uprights in a vertical direction through the plurality of grid spaces, the load-handling device comprising:
a body or skeleton mounted on:
a first set of wheels configured to engage with the first set of parallel rails or tracks; and
a second set of wheels configured to engage with the second set of parallel rails or tracks;
a container-lifting assembly comprising one of the first motor or the second motor, wherein the one of the first motor or the second motor is configured to raise or lower a gripping device in the vertical direction; and
a direction-change assembly comprising another of the first motor or the second motor, wherein the other of the first motor or the second motor is configured to at least one of:
raise or lower the first set of wheels with respect to the body or skeleton of the load-handling device to engage or disengage the first set of wheels with the first set of parallel rails or tracks, or
lower or raise the second set of wheels with respect to the body or skeleton of the load-handling device to engage or disengage the second set of wheels with the second set of parallel rails or tracks.

13. The system of claim 9, wherein the load-handling device is configured to lift and move storage containers stacked in a grid framework structure, the grid framework comprising:
a first set of parallel rails or tracks and a second set of parallel rails or tracks, the second set of parallel rails or tracks extending substantially perpendicularly to the first set of parallel rails or tracks in a substantially horizontal plane to form a grid pattern, the grid pattern comprising a plurality of grid spaces, wherein the grid pattern is supported by a set of uprights to form a plurality of vertical storage locations beneath the grid pattern for storage containers to be stacked between and be guided by the set of uprights in a vertical direction through the plurality of grid spaces, the load-handling device comprising:
a body or skeleton mounted on:
a first set of wheels configured to engage with the first set of parallel rails or tracks; and
a second set of wheels configured to engage with the second set of parallel rails or tracks; and
a drive assembly comprising the first motor and the second motor, wherein:
the first motor is configured to drive the first set of wheels to move the load-handling device along the first set of parallel rails or tracks, and
the second motor is configured to drive the second set of wheels to move the load-handling device along the second set of parallel rails or tracks.

14. The system of claim 13, wherein the load-handling device further comprises:
a direction-change assembly configured to at least one of:
raise or lower the first set of wheels with respect to the body or skeleton of the load-handling device to engage or disengage the first set of wheels with the first set of parallel rails or tracks, or
lower or raise the second set of wheels with respect to the body or skeleton of the load-handling device to engage or disengage the second set of wheels with the second set of parallel rails or tracks.

15. A method for dissipating electrical energy generated by a motor, comprising:
driving a first motor;
detecting electrical energy generated by the first motor;
diverting at least a first portion of the electrical energy generated by the first motor to a second motor; and
controlling, via field oriented control or vector control, the second motor to sink the at least the first portion of the electrical energy generated by the first motor in a direct axis of the second motor.
